(19) United States
(12) Patent Application Publication
(10) Pub. No.: US 2011/0029889 A1
(43) Pub. Date: Feb. 3, 2011

(54) SELECTIVE AND ON-DEMAND REPRESENTATION IN A VIRTUAL WORLD

(75) Inventor: Christopher Kent Karstens, Apex, NC (US)

Correspondence Address: WILSON HAM & HOLMAN/RSW, 175 S Main Street, Suite #850, Salt Lake City, UT, 84111, US

(73) Assignee: INTERNATIONAL BUSINESS MACHINES CORPORATION, Armonk, NY (US)

(21) Appl. No.: 12/533,370

(22) Filed: Jul. 31, 2009

(51) Int. Cl. G06F 3/048; G06F 3/01

(52) U.S. Cl. 715/745; 715/757

(57) ABSTRACT

A metaverse system and method for representing multiple versions of a user's avatar to other users of a virtual world. The system includes a metaverse server connected to a network. The metaverse server executes a metaverse application. The metaverse application enables an avatar of a first user to interact with avatars of other users within a metaverse virtual world. The system also includes a representation engine connected to the metaverse server. The representation engine conveys a first representation of the avatar of the first user to a second user according to a default profile. The representation engine simultaneously conveys a second representation of the avatar of the first user to a third user according to an alternative profile. The alternative profile is typically different from the default profile. Other embodiments of the system are also described.

### BACKGROUND

The term metaverse is widely used to describe a fully immersive 3D virtual space, which includes a virtual environment where humans are represented by avatars. An avatar is typically a 3D humanoid version of the user. In this way, users may interact with other users, both socially and economically, through their respective avatars and with software agents in a cyber space. The virtual environment in a metaverse is built upon a metaphor of the real world, but in most cases, without the physical limitations of the real world. In a metaverse application, such as Second Life®, users, through their avatars, are allowed to have friends, create groups, and talk and mingle with strangers, fly, and teleport to different locations, and different metaverses.

Currently, a user in a metaverse is able to interact with other users in the metaverse using a single representation of their avatars. In other words, a user's avatar appears the same way to other users. On any given day the user may direct their avatar to enter a work setting such as a conference room to interact with clients, a social area such as a club, and a virtual home of friends or family. In each instance, the user's avatar appears the same. Additionally, the user's avatar sounds the same way to other users. In the case of using a microphone, the user speaks into the microphone, and the user's computer converts the audio input from the user to a digitally sampled version. The digital version of the audio is then relayed from the user's computer to one or more other users' computers over the internet using a protocol such as Voice over Internet Protocol (VoIP). Hence, currently the user's avatar looks and sounds the same to all other users regardless where the user's avatar is located or with whom the user is interacting.

Conventionally, a user may modify the appearance of the user's avatar. However, the modification requires manual intervention. Additionally, if the user modifies the appearance of the user's avatar, then all other users will see the modified version of the user's avatar. In other words, after changing the appearance of his or her avatar to a business/professional appearance to attend a business meeting, the user may then go to a social club dressed in the business/professional attire. Although the user could manually change the appearance of his or her avatar to a casual/social attire, the modification would require the user to remember to make the change and then manual intervention to implement the change. Thus, the conventional solution to adapt the image and appearance of a user's avatar is limited because it requires the user to remember to make the change in attire and to manually intervene to implement the change in attire.

### SUMMARY

Embodiments of a system are described. In one embodiment, the system is an avatar representation system. The system includes a metaverse server connected to a network. The metaverse server executes a metaverse application. The metaverse application enables an avatar of a first user to interact with avatars of other users within a metaverse virtual world. The system also includes a representation engine connected to the metaverse server. The representation engine conveys a first representation of the avatar of the first user to a second user according to a default profile. The representation engine simultaneously conveys a second representation of the avatar of the first user to a third user according to an alternative profile. The alternative profile is typically different from the default profile. Other embodiments of the system are also described.

Embodiments of a method are also described. In one embodiment, the method is a method for representing multiple versions of an avatar in a virtual world. The method includes executing a metaverse application to enable an avatar of a first user to interact with avatars of other users within the metaverse virtual world. The method also includes conveying a first representation of the avatar of the first user to a second user according to a default profile, recognizing a profile trigger associated with an alternative profile, and dynamically conveying a second representation of the avatar of the first user to a third user according to the alternative profile while continuing to convey the first representation to the second user. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE SEVERAL VIEWS OF THE DRAWINGS

FIG. 1 depicts a schematic diagram of one embodiment of a computer network system.

FIG. 2 depicts a schematic block diagram of one embodiment of a client computer of the computer network system of FIG. 1.

FIG. 3 depicts a schematic diagram of one embodiment of the metaverse server of the computer network system of FIG. 1 for use in association with the profile configuration interface of FIG. 2.

FIG. 4 depicts a schematic diagram of one embodiment of a profile configuration interface for use with the metaverse client viewer of FIG. 2.

FIG. 5 depicts a schematic diagram of another embodiment of the profile configuration interface for use with the profile configurator of FIG. 3.

FIG. 6 depicts a schematic flow chart diagram of one embodiment of a profile configuration method for use with the representation engine of FIG. 3.

FIG. 7 depicts a schematic flow chart diagram of one embodiment of a multi-profile representation method for use with the representation engine of FIG. 3.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated. The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments facilitate portraying multiple representations of a user's avatar in a metaverse server. An example of a metaverse server includes a Second Life® server. This and other metaverse servers serve a virtual world simulation, or metaverse, through a software application that may be stored and executed on a computer system.

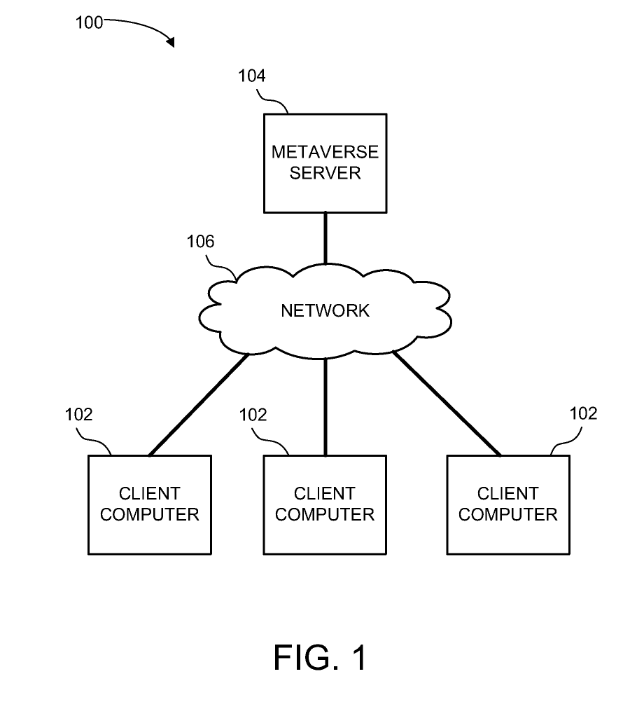

FIG. 1 depicts a schematic diagram of one embodiment of a computer network system 100. The illustrated computer network system 100 includes a client computer 102, a metaverse server 104, and a network 106. The computer network system 100 may provide an interface between a system user and a metaverse server 104 according to the interface operations of the client computer 102. Although the depicted computer network system 100 is shown and described herein with certain components and functionality, other embodiments of the computer network system 100 may be implemented with fewer or more components or with less or more functionality. For example, some embodiments of the computer network system 100 include a plurality of metaverse servers 104 and a plurality of networks 106. Additionally, some embodiments of the computer network system 100 include similar components arranged in another manner to provide similar functionality, in one or more aspects.

The client computer 102 manages the interface between a system user and the metaverse server 104. In one embodiment, the client computer 102 is a desktop computer or a laptop computer. In other embodiments, the client computer 102 is a mobile computing device that allows a user to connect to and interact with the metaverse server 104. In some embodiments, the client computer 102 is a video game console. The client computer 102 is connected to the metaverse server 104 via a local area network (LAN) or other type of network 106.

The metaverse server 104 hosts a simulated virtual world, or a metaverse, for a plurality of client computers 102. In one embodiment, the metaverse server 104 is an array of servers. In one embodiment, a specified area of the metaverse is simulated by a single server instance, and multiple server instances may be run on a single metaverse server 104. In some embodiments, the metaverse server 104 includes a plurality of simulation servers dedicated to physics simulation in order to manage interactions and handle collisions between characters and objects in a metaverse. The metaverse server 104 also may include a plurality of storage servers, apart from the plurality of simulation servers, dedicated to storing data related to objects and characters in the metaverse world. The data stored on the plurality of storage servers may include object shapes, avatar profiles and appearances, audio clips, metaverse related scripts, and other metaverse related objects.

The network 106 may communicate traditional block I/O. The network 106 may also communicate file I/O such as a transmission control protocol / internet protocol (TCP/IP) network or similar communication protocol. In some embodiments, the computer network system 100 includes two or more networks 106. In another embodiment, the client computer 102 is connected directly to a metaverse server 104 via a backplane or system bus. In one embodiment, the network 106 includes a cellular network, other similar type of network, or combination thereof.

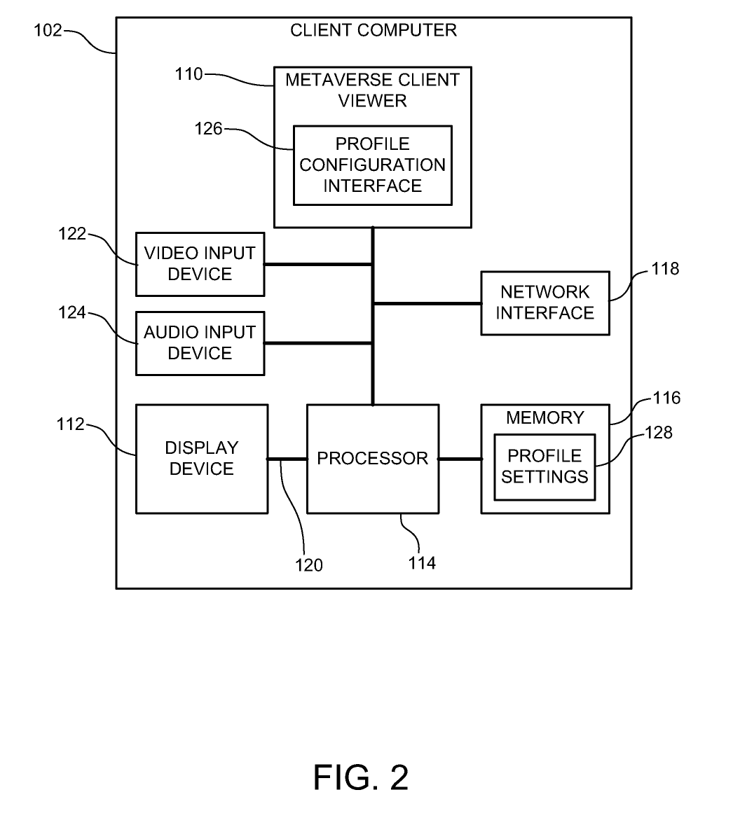

FIG. 2 depicts a schematic block diagram of one embodiment of a client computer 102 of the computer network system 100 of FIG. 1. The illustrated client computer 102 includes a metaverse client viewer 110, a display device 112, a processor 114, a memory device 116, a network interface 118, a bus interface 120, a video input device 122, and an audio input device 124. In one embodiment, the bus interface 120 facilitates communications related to software associated with the metaverse client viewer 110 executing on the client computer 102, including processing metaverse application commands, as well as storing, sending, and receiving data packets associated with the application software of the metaverse. Although the depicted client computer 102 is shown and described herein with certain components and functionality, other embodiments of the client computer 102 may be implemented with fewer or more components or with less or more functionality.

In one embodiment, the client computer 102 of FIG. 2 implements the metaverse client viewer 110 coupled to a metaverse server 104 attached to the network 106 of FIG. 1. In some embodiments, the metaverse client viewer 110 is stored in the memory device 116 or a data storage device within the client computer 102. In some embodiments, the metaverse client viewer 110 includes processes and functions which are executed on the processor 114 within the client computer 102.

In one embodiment, the metaverse client viewer 110 is a client program executed on the client computer 102. In some embodiments, the metaverse client viewer 110 enables a user on a client computer 102 to connect to a metaverse server 104 over a network 106. The metaverse client viewer 110 is further configured to enable a user on the client computer 102 to interact with other users on other client computers 102 that are also connected to the metaverse server 104. The depicted metaverse client viewer 110 includes a profile configuration interface 126.

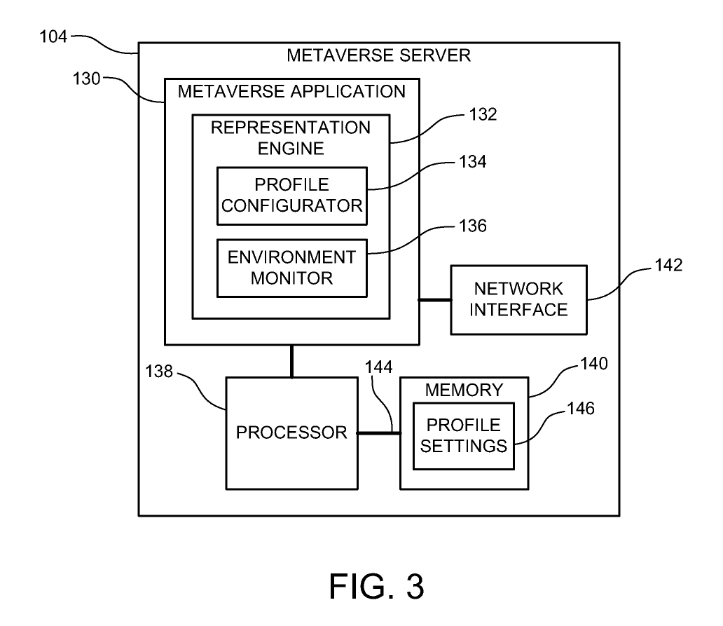

In one embodiment, the profile configuration interface 126 is configured to allow the user to create and configure default and alternative profiles. In other words, the profile configuration interface 126 allows a user to configure a first representation of the user's avatar that may be visually and aurally communicated to a client computer of a second user, and to configure a second representation of the user's avatar that may be simultaneously communicated visually and aurally to a client computer of a third user. Embodiments of the process to configure simultaneous representations of a user's avatar are described in further detail below in relation to FIG. 3.

In one embodiment the video input device 122 is configured to allow a user to control a facial expression and/or a gesture of the user's avatar in the metaverse virtual world. In other words, the video input device 122 interprets the actual facial expression and/or actual gesture of the user. In one embodiment, the video input device 122 sends a video signal or another signal of the facial expression and/or gesture to the client processor 114.

In one embodiment, the audio input device 124 allows a user to verbally speak to other users in the metaverse virtual world. In one embodiment, the audio input device 124 sends an audio signal representative of the user's audio input to the client processor 114.

In some embodiments, the display device 112 is a graphical display such as a cathode ray tube (CRT) monitor, a liquid crystal display (LCD) monitor, or another type of display device. In one embodiment, the display device 112 is configured to convey a visual representation of a metaverse virtual world. The display device 112 allows a user to control and configuration tools to control and configure aspects of the metaverse client viewer 110, as well as the processes related to simultaneous representations of a user's avatar.

In one embodiment, the processor 114 is a central processing unit (CPU) with one or more processing cores. In other embodiments, the processor 114 is a graphical processing unit (GPU) or another type of processing device such as a general purpose processor, an application specific processor, a multi-core processor, or a microprocessor. Alternatively, a separate GPU may be coupled to the display device 112. In general, the processor 114 executes one or more instructions to provide operational functionality to the client computer 102. The instructions may be stored locally in the processor 114 or in the memory device 116. Alternatively, the instructions may be distributed across one or more devices such as the processor 114, the memory device 116, or another data storage device.

In one embodiment, the processor 114 is configured to receive a video signal from the video input device 122 on a first client computer 102 of a first user, to analyze the signal, and to generate an allowed expression associated with the alternative profile in response to the selection of the alternative profile and/or the analysis of the signal. The processor 114 is configured to display the generated expression as an expression of the first user's avatar on a second client computer of a second user.

In one embodiment, the processor 114 is configured to receive an audio signal from the audio input device 124 on a first client computer 102 of the first user, to modify the audio signal according to the voice type associated with the alternative profile and/or the analysis of the audio signal, and to output the modified audio signal to a second client computer 102 of the second user. In one embodiment, a male user's voice is communicated as a female voice. Likewise, a female user's voice may be communicated as a male voice. In one embodiment, the volume of the first user's voice is reduced from a loud level to a quieter level. Likewise, the volume of the first user's voice may be increased from a relatively quiet level to a louder level. In one embodiment, the first user's voice is translated from the language spoken by the first user to another language such as from English to Spanish. For example, the first user's profile may state that the first user only speaks and understands English. The second user's profile may state that the second user only speaks and understands Spanish. Based on these profile settings, the first and second user's can communicate through an automated translation of their spoken words, for example, using known automated translation technology. In one embodiment a first user's voice is communicated as a robot voice.

The illustrated memory device 116 includes client profile settings 128. In some embodiments, the client profile settings 128 are used in conjunction with the processes related to representing multiple versions of a user's avatar. Embodiments of the process of representing multiple versions of a user's avatar are described in further detail below in relation to FIG. 3. In some embodiments, the memory device 116 is a random access memory (RAM) or another type of dynamic storage device. In other embodiments, the memory device 116 is a read-only memory (ROM) or another type of static storage device. In other embodiments, the illustrated memory device 116 is representative of both RAM and static storage memory within a single computer network system 100. In other embodiments, the memory device 116 is an electronically programmable read-only memory (EPROM) or another type of storage device. Additionally, some embodiments store the instructions related to the operational functionality of the client computer 102 as firmware such as embedded foundation code, basic input/output system (BIOS) code, or other similar code.

The network interface 118, in one embodiment, facilitates initial connections between the client computer 102 and the metaverse server 104 in response to a user on the client computer 102 requesting to login to the metaverse server 104 and to maintain a connection established between the client computer 102 and the metaverse server 104. In some embodiments, the network interface 118 handles communications and commands between the client computer 102 and the metaverse server 104. The communications and commands are exchanged over the network 106.

In one embodiment, the display device 112, the processor 114, the memory device 116, the network interface 118, and other components within the computer network system 100 may be coupled to a bus interface 120. The bus interface 120 may be configured for simplex or duplex communications of data, address, and/or control information.

FIG. 3 depicts a schematic diagram of one embodiment of a metaverse server 104 of the computer network system of FIG. 1 for use in association with the profile configuration interface 126 of FIG. 2. The illustrated metaverse server 104 includes a metaverse application 130, a processor 138, an electronic memory device 140, a network client 142, and one or more bus interfaces 144. The illustrated metaverse application 130 includes a representation engine 130, which includes a profile configurator 134 and an environment monitor 136. In one embodiment, the bus interfaces 144 facilitate communications related to execution of the metaverse application 130 on the metaverse server 104, including processing metaverse application commands, as well as storing, sending, and receiving data associated with the metaverse application 130. Although the depicted metaverse server 104 is shown and described herein with certain components and functionality, other embodiments of the metaverse server 104 may be implemented with fewer or more components or with less or more functionality.

The illustrated metaverse server 104 of FIG. 3 includes many of the same or similar components as the client computer 102 of FIG. 2. These components are configured to operate in substantially the same manner described above, except as noted below.

In one embodiment, the metaverse application 130, when executed on a metaverse server 104, simulates a fully immersive three-dimensional virtual space, or metaverse, that a user on a client computer 102 may enter and interact within via the metaverse client viewer 110. Thus, several users, each on their own client computer 102, may interact with each other and with simulated objects within the metaverse. Alternatively, at least one element and/or structure of the representation engine 130 may be located on a client computer 102. For example, at least one of the subcomponents of the representation engine 130 such as the profile configurator 134 or the environment monitor 136 may be located on the client computer 102. Hence, in some embodiments, at least some functionality of the representation engine 130 and/or a subcomponent of the representation engine 130 may occur on the client computer 102.

The representation engine 132 provides functionality within the metaverse application 130 to convey a first representation of a first user's avatar to a second user according to a default profile. The representation engine 132 simultaneously conveys a second representation of the first user's avatar to a third user according to an alternative profile. In other words, the first user's avatar simultaneously appears differently to different users. For example, the first user's default representation of his or her avatar may include casual clothing, a casual voice, and allow any facial expression to be displayed on the other user's display device. On the other hand, the first user's alternative representation of his or her avatar may include business/professional clothing, a professional/serious voice, and only allow facial expressions such as smiling and attentive-listening.

In one embodiment, the representation engine is configured to dynamically recognize a profile trigger of the alternative profile and to dynamically implement the alternative profile in response to the profile trigger. Hence, the first user's avatar appears in the default representation to one of his or her friends whenever the first user's avatar is within a visual field of the friend, but appears in the alternative representation to one of his or her business clients whenever the first user's avatar is within a visual field of the business client.

In one embodiment, the profile configurator 134 is configured to allow a first user to configure profile characteristics of the default and alternative profiles. The profile configurator 134 stores the default and the alternative profiles in a memory storage device 140. Each of the default and alternative profiles includes at least one profile characteristic. Profile characteristics may include, but are not limited to, avatar traits such as hair color, hair style, clothing, age, gender, race, height, weight, body type, voice type, gestures, and allowed expressions. Gestures may include hand waving, laughing, sitting, dancing, etc. Allowed expressions may include smiling, frowning, surprise, anger, interested listening, disgust, etc. In other words, allowed expressions typically include expressions of the avatar's face, but may include further types of expressions associated with the audio and visual characteristics of a user's avatar. For example, the profile configurator 134 may be configured to limit physical gestures of a user. In particular, in one embodiment, the profile configurator 134 is configured to reduce or eliminate a behavior of a user with physical disabilities and/or motor skill deficiencies.

In one embodiment, the profile configurator 136 is configured to allow a first user to configure a profile trigger. The profile configurator 136 stores the profile trigger in a memory storage device 140. The profile trigger may include such triggers as an activation time, an activation location, and an activation contact. The activation time includes a time of day within the virtual world that indicates when the alternative profile is represented to another user. The activation location includes a location within the virtual world where the avatar is located to trigger a profile associated with that location. The activation contact includes a name of another user's avatar or a contact-type classifier that determines to whom the alternative profile is represented.

In one embodiment, the profile configurator 135 allows the first user to configure multiple alternative profiles. Hence, in one example, a second user sees the first user's avatar as a business-attired human avatar and hears the first user speak in English when the first user speaks. A third user sees the first user's avatar as a casual-attired human avatar and hears the first user speak in Spanish when the first user speaks. A fourth user sees the first user's avatar as a robot avatar with robotic gestures and hears a robotic/metallic voice when the first user speaks. Additionally, other users simultaneously may see and hear the first user's avatar according to other avatar profiles.

In one embodiment, the environment monitor 136 monitors at least one of several environmental cues of the metaverse virtual world. The environmental cues include at least the time of day in the virtual world, the location of the avatar in the virtual world, and the presence of another avatar within a predetermined distance of the first user's avatar. Other embodiments may use other types of environmental cues. The environment monitor 136 is configured to compare at least one of the environmental cues to at least one profile trigger. The environment monitor 136 implements the alternative profile in response to a match between at least one of the environmental cues and at least one of the profile triggers associated with the alternative profile.

In one embodiment, the environment monitor 136 is configured to monitor profile characteristics of a second user's avatar. The environment monitor 136 sends a monitor signal to the representation engine 132 to instruct the representation engine 132 to adapt at least one profile characteristic of the first user's avatar to match at least one of the profile characteristics of the second user's avatar. The representation engine 132 simultaneously represents the audio and visual profile characteristics of the avatar of the first user to the second user according to the profile characteristics of the second user's avatar. For example, a first user's avatar may work at a virtual retail store. The default appearance of the first user's avatar is a male avatar about 20 years old. A second user's avatar may enter the store and approach the first user's avatar for help. The second user's avatar may be depicted as a male about 60 years old. Hence, in one embodiment, the environment monitor 136 sends a monitor signal to the representation engine 132 to instruct the representation engine 132 to adapt the age appearance of the first user's avatar to match the age appearance of the second user's avatar. In other words, at least one audio or visual trait of the second user's avatar appears on or is heard from the first user's avatar, giving the two avatars something in common.

In one embodiment, the environment monitor 136 is configured to monitor a profile preference of a second user. The profile preference of the second user includes a preference of how the second user would like to see and hear the first user's avatar. In other words, the environment monitor 136, in one embodiment, sends a monitor signal to the representation engine 132 to instruct the representation engine 132 to adapt the appearance of the first user's avatar to match the profile preference of the second user. The profile preference includes at least one of the profile characteristics described above. Hence, the representation engine 132 modifies at least one audio and/or visual characteristic of the first user's avatar to match the second user's profile preference. For example, as above, a first user's avatar may work as a manager at a virtual retail store. The default appearance of a manager avatar is an avatar with a red vest. The default appearance of a salesman is an avatar with a blue vest. A second user's avatar may enter the store and want to speak with the manager. The second user's profile preference may specify a preference that managers wear orange and salesman to wear yellow. In one embodiment, the profile preferences of the second user are implanted if the profile settings of the virtual retail store allows for a change in employee apparel. Hence, in one embodiment, the environment monitor 136 sends a monitor signal to the representation engine 132 to instruct the representation engine 132 to adapt the appearance of the first user's avatar to match the profile preferences of the second user's avatar according to any limits the virtual retail store places on the appearance of employee avatars.

In one embodiment, the environment monitor 136 is configured to monitor location characteristics of an area in the virtual world such as an island, a club, a school, or an office. An island in the virtual world may provide customs/preferences associated with the island such as attire characteristics and language characteristics. In this way, a user can configure an avatar profile to dynamically adapt the visual and audio characteristics of the user's avatar according to the preferences of a location (i.e., a location profile) within the virtual world.

In some embodiments, the user may configure the representation engine 132 to dynamically adjust how the user's avatar looks and sounds based on the visual and audio characteristics of other users. Thus, the user may configure a “blend in” avatar profile. For example, if other avatars are dressed casually, then the user's avatar is represented in casual dress to other users. In contrast, the user may configure a “stand out” avatar profile. For example, if other avatars are dressed in red shirts, then the user's avatar is represented in a blue shirt to other avatars.

In another embodiment, the environment monitor 136 monitors the virtual weather and/or time-of-day conditions of the virtual world. For example, if it is virtually light outside, and the user's avatar is located outdoors, the avatar may be seen by other user's wearing sunglasses. If the user's avatar goes indoors or it is virtually dark outside, then the avatar is no longer seen wearing sunglasses (i.e., the sunglasses are automatically removed). In another example, the user's avatar may be seen wearing a jacket when it is virtually cold outside and the avatar is outside. If the user's avatar goes indoors, then the avatar is seen without the jacket. In another example, the user's avatar is seen holding an open umbrella overhead when it is virtually raining outside and the user's avatar is outside. If the user's avatar goes indoors, then the avatar is seen without the open umbrella.

The illustrated memory device 140 includes server profile settings 146. In some embodiments, the server profile settings 146 are used in conjunction with the processes related to representing multiple versions of a user's avatar. The server profile settings 146 include the information associated with the default and alternative profiles configured by the user via the profile configurator 134. This information may include the profile triggers and the profile characteristics of the user's avatar. In one embodiment, the metaverse client viewer 110 is stored in the electronic memory device 116 or a data storage device within a client computer 102. Alternatively, the metaverse client viewer 110 may be stored in the electronic memory device 140 or a data storage device within the metaverse server 104. In one embodiment, the metaverse application 130 includes processes and functions which are executed on the processor 138 within the metaverse server 104.

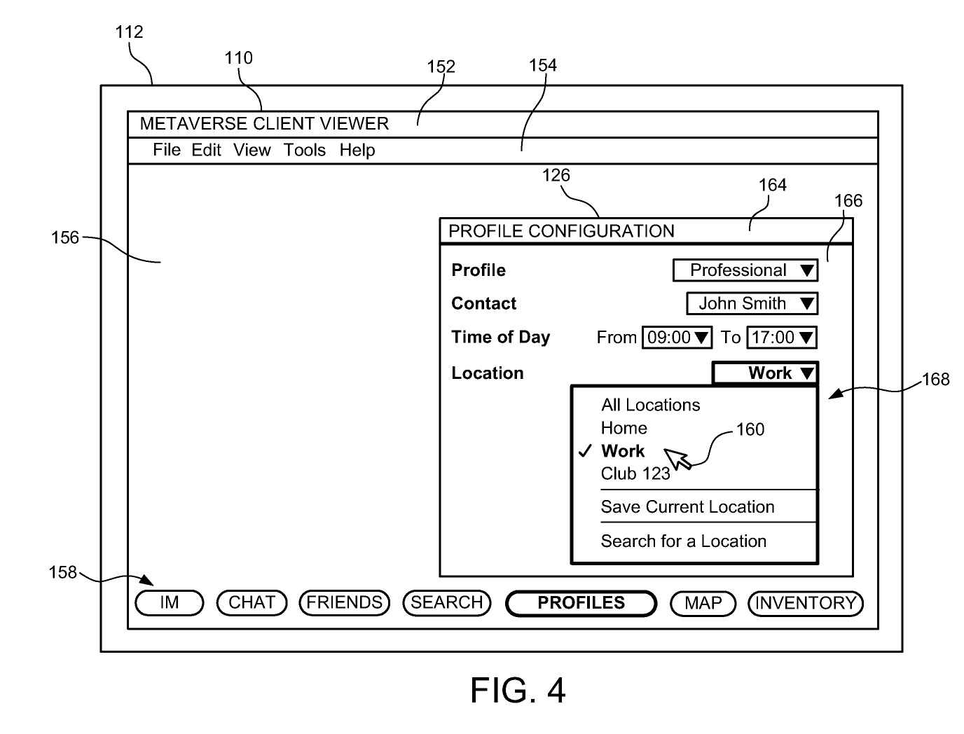

FIG. 4 depicts a schematic diagram of one embodiment of a profile configuration interface 126 for use with the metaverse client viewer 110 of FIG. 2. In particular, the metaverse client viewer 110 shows the profile configuration interface 126 within a graphical user interface (GUI) for display on a display device 112. In one embodiment, the profile configuration interface 126 interfaces a user on the client computer 102 with the profile configurator 134. It should be noted that other embodiments of the profile configuration interface 126 may be integrated with existing or new interfaces that are used to display related information.

The illustrated metaverse client viewer 110 includes a title bar 152 to show a title of the metaverse client viewer 110, a menu bar 154 to show possible menu selections within the metaverse client viewer 110, a viewing space 156 to show a metaverse within the metaverse client viewer 110, several metaverse client viewer control buttons 158, including a PROFILES button, and a profile configuration interface 126 to show several profile configuration options within the metaverse client viewer 110. The illustrated metaverse client viewer 110 also depicts a cursor 160 in relation to the profile configuration interface 126, which, in one embodiment, opens the profile configuration interface 126.

The illustrated profile configuration interface 126 includes a title bar 164 to show a title of the profile configuration interface 126, a profile configuration viewing space 166 to show several profile configuration options, and several profile configuration control interfaces 168, which may include a drop-down menu, a checkbox, a radio button, a single-click button, among other possible profile control interfaces 168. Other embodiments may include fewer or more profile configuration options.

The illustrated profile configuration control interfaces 168 include a profile selection, a contact selection, a time of day selection, and a location selection. These configuration options allow the user to configure which profile is used to represent the user's avatar to another user depending on the indicated parameters. Thus, a user may configure several representations, or profiles, of the user's avatar according to the settings selected by the user through the profile configuration interface 126. In some embodiments, the profile may then be saved for later use through the same profile configuration interface 126. Details of these profile configuration options are configured to operate in substantially the same manner described above in relation to FIG. 3. In the illustrated example, the user selects a professional profile. The professional profile may include avatar traits that represent the user's avatar in a professional appearance/persona. Hence, the professional representation may include an avatar in a business suit, with a business/professional hair style, using professional expressions, and with a business type of voice. The user selects one or more contacts associated with the professional profile. In this case, the user selects John Smith. Hence, the user's avatar appears and speaks in a professional manner when the avatar of the user John Smith is within a predetermined visual radius of the user's avatar. Alternatively, the user associates several contacts with a particular avatar profile. Additionally, the user may select a group or type of contacts other than specific individual avatars.

As illustrated, the user selects a time of day between 9:00 A.M. and 5:00 P.M. In other words, the user implements a time-limit on the professional profile. During the indicated hours, the avatar appears in the professional representation to the specified viewer(s). Outside of the indicated hours, the avatar may appear in a default or other representation.

As illustrated, the user may select a location to associate with the indicated professional profile/representation of the user's avatar. In other words, the user implements a location-limit on the professional profile. When the user's avatar is at the indicated location, the avatar may appear in the professional representation. Outside of the indicated location the avatar appears in a default representation.

Putting the profile configuration options together, as provided in this example, the user's avatar will appear in a professional representation when the user's avatar appears to John Smith at the Work location between the hours of 9:00 A.M. and 5:00 P.M. Hence, the profile configuration options are profile triggers that trigger when, where, and to whom the selected representation is used to represent the user's avatar. The user may narrow the scope of the triggers by selecting triggers for each of the contact, time of day, and location triggers. Alternatively, the user may select only one trigger to broaden the scope of the triggers. In other words, the user may select only a time of day trigger, leaving the contact and location triggers to remain unselected. In this case, the user's selected representation of his or her avatar will appear to all other users in the virtual world during the selected time period regardless of which particular contacts are within a predefined visual radius of the user's avatar or the location of the user's avatar. Outside of the indicated time span the avatar may appear in a default or other representation.

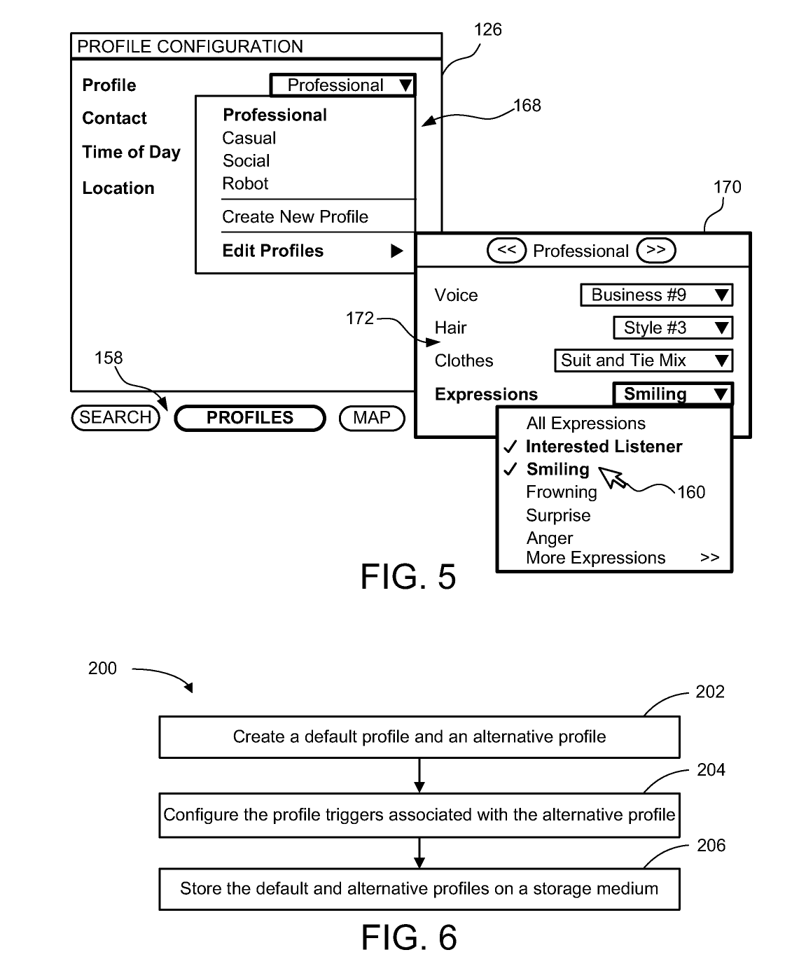

FIG. 5 depicts a schematic diagram of another embodiment of the profile configuration interface 126 for use with the profile configurator 134 of FIG. 3. In association with the profile configuration interface 126, FIG. 5 also depicts the cursor 160 clicking on a profile configuration option among a representative menu of profile configuration control interfaces 168 depicted in FIG. 4. In one embodiment, the profile configuration interface 126 is accessed via the illustrated PROFILES control button among the control buttons 158 of the metaverse client viewer 110 of FIG. 4. In some embodiments, a user clicks on the PROFILES control button via the cursor 160 to open the profile configuration interface 126.

The illustrated profile configuration interface 126 includes the profile configuration control interfaces 168 to allow the user to configure an avatar representational profile, an edit profiles menu 170 to allow the user to modify an existing avatar representational profile, which may include a drop-down menu, a checkbox, a radio button, a single-click button, among other possible profile editing interfaces 172. As illustrated, the profile editing interfaces 172 include a voice drop-down menu to allow a user to select a type of voice associated with the selected profile, a hair drop-down menu to allow a user to select a type of hair style associated with the selected profile, a clothes drop-down menu to allow a user to select type of clothing associated with the selected profile, and an expressions down menu to allow a user to select the type of expressions associated with the selected profile. Each drop-down menu of the profile editing interfaces 172 allows the user to configure one or more avatar traits of the selected avatar profile. As illustrated, the clothing drop-down menu may include a mix of clothing from which the representation engine 132 chooses from according to user preference. The illustrated suit and tie mix may include a range of different suits and ties in which the representational engine 132 may virtually dress the user's avatar. The representational engine 132 either selects the suit by random or by a predetermined order/sequence. For example, the user may virtually purchase three different business suits: a black suit, a gray suit, and a blue suit. With the suit and tie mix selected, the representational engine 132 sequences through the different suits based on a predetermined sequence such as one different suit per virtual day, and so forth.

In particular, FIG. 5 depicts the cursor 160 clicking on the expressions drop-down menu to select the facial expressions that are allowed in the selected professional profile. A user may select one or more expressions to associate with the selected profile among the listed expressions. The expressions of interested listener and smiling are selected (shown in bold) as depicted in FIG. 5. In other words, under the professional profile the only the expressions of smiling and interested listener are allowed. In one embodiment, in association with the video input device 122, if the video input device 122 detects the user frowning, but the only allowed expressions are interested listener and smiling, then the frowning expression is ignored and the user's avatar is only seen smiling and/or listening attentively. Alternatively, other embodiments may include fewer or more profile configuration options and functions. In some embodiments, the profile settings described above are stored in the memory device 116 and/or 140.

FIG. 6 depicts a schematic flow chart diagram of one embodiment of a profile configuration method 200 for use with the representation engine 132 of FIG. 3. For ease of explanation, the profile configuration method 200 is described with reference to the representation engine 132 of FIG. 3. However, some embodiments of the profile configuration method 200 may be implemented with other representation engines. Additionally, the profile configuration method 200 is described in conjunction with the metaverse client viewer 110 of FIG. 2, but some embodiments of the profile configuration method 200 may be implemented with other metaverse client viewers.

In the illustrated profile configuration method 200, a user in a metaverse virtual world creates 202 a default profile and an alternative profile. In some embodiments, a user may create an avatar representational profile via the “Create New Profile” menu option illustrated in the profile configuration control interfaces 168 of FIG. 5. In some embodiments, a default profile auto-creates when a user enters the metaverse virtual world for the first time.

In the illustrated profile configuration method 200, the user configures 204 the profile triggers associated with the alternative profile. As explained above in relation to FIG. 3, the profile triggers include such triggers as an activation time, an activation location, and/or an activation contact. The user then stores 206 the default and alternative profiles on a storage medium. Additionally, the user may store 206 the profile triggers associated with the alternative profile. In one embodiment, the user stores 206 the profiles and profile triggers on the client memory device 116. Alternatively, the user stores 206 the profiles and profile triggers on the server memory device 140. Additionally, the user may store the profiles and profile triggers across both the client and the server memory devices 116 and 140, respectively. The depicted method 200 then ends.

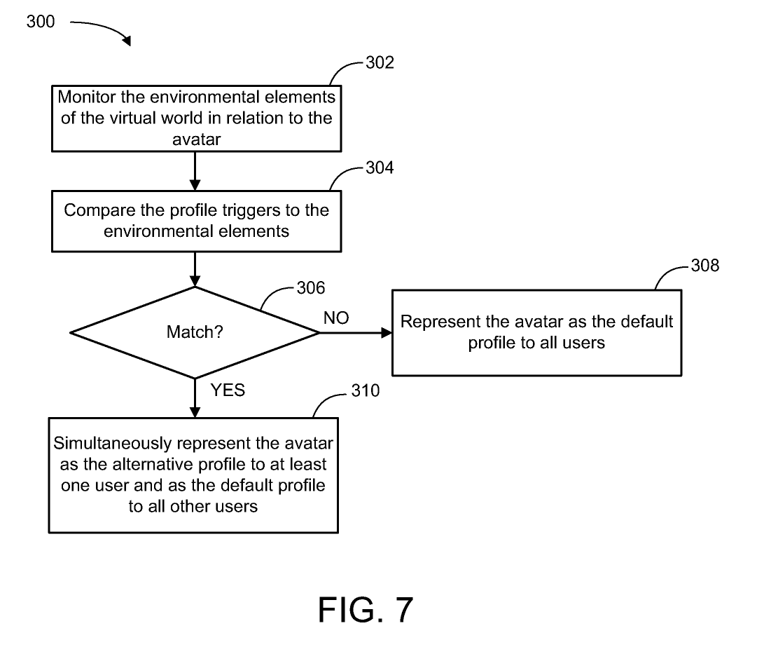

FIG. 7 depicts a schematic flow chart diagram of one embodiment of a multi-profile representation method 300 for use with the representation engine 132 of FIG. 3. For ease of explanation, the multi-profile representation method 300 is described with reference to the representation engine 132 of FIG. 3. However, some embodiments of the multi-profile representation method 300 may be implemented with other representation engines. Additionally, the multi-profile representation method 300 is described in conjunction with the metaverse client viewer 110 of FIG. 2, but some embodiments of the multi-profile representation method 300 may be implemented with other metaverse client viewers.

In the illustrated multi-profile representation method 300, the environment monitor 136 monitors 302 the environmental cues of the virtual world in relation to the user's avatar. In one embodiment, the environmental cues include at least the time of day in the virtual world, the location of the avatar in the virtual world, and another avatar that is within a predetermined radius of the first user's avatar. The environment monitor 136 then compares 304 the profile triggers associated with the alternative profile to the environmental cues. The environment monitor 136 then determines whether a match exists between the profile triggers and the environmental cues. When the environment monitor 136 fails to find a match between the profile triggers and the environment cues, the representation engine 132 represents 308 the avatar as the default profile to all users. Otherwise, when the environment monitor 136 finds a match between the profile triggers and at least one of the environment cues, the representation engine 132 simultaneously represents 310 the avatar as the alternative profile to at least one user and as the default profile to all other users. As part of representing the avatar to different people using different profiles, the video and audio input devices 122 and 124 may receive video and audio input signals, respectively, and the processor 114 and/or 138 modifies the appearance and the voice of the avatar according to the alternative profile. Embodiments of the functions of the processors 114 and/or 138 in relation to the illustrated multi-profile representation method 300 are explained in further detail above in relation to FIGS. 2 and 3. The depicted method 300 then ends.

Embodiments of the systems and methods of the metaverse profile representation process described above can have a real and positive impact on improving the usability of a metaverse application 130, by providing a process of dynamically and simultaneously representing multiple representations of one's avatar. In other words, a first user may dynamically represent a default representation of the first user's avatar to a second user while simultaneously and dynamically representing an alternative representation of the first user's avatar to a third user. Additionally, some embodiments facilitate improving interaction of avatars in commercial settings, by providing a process to dynamically modify the appearance of one's avatar based on another user's preference or appearance. Thus, by eliminating the limitation of a single representation requiring manual intervention for modification, a user's experience in the metaverse is improved and enhanced.

It should also be noted that at least some of the operations for the methods may be implemented using software instructions stored on a computer usable storage medium for execution by a computer. As an example, an embodiment of a computer program product includes a computer usable storage medium to store a computer readable program that, when executed on a computer, causes the computer to perform operations, including an operation to execute a metaverse application. The metaverse application enables an avatar of a first user to interact with avatars of other users within a metaverse virtual world. The operations also include an operation to convey a first representation of the avatar of the first user to a second user according to a default profile. The operations also include an operation to simultaneously convey a second representation of the avatar of the first user to a third user according to an alternative profile.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable storage medium providing program code for use by or in connection with a computer or any instruction execution system. For the purposes of this description, a computer-usable or computer readable storage medium can be any apparatus that can store the program for use by or in connection with the instruction execution system, apparatus, or device.

The computer-usable or computer-readable storage medium can be an electronic, magnetic, optical, electromagnetic, infrared, or semiconductor system (or apparatus or device), or a propagation medium. Examples of a computer-readable storage medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product comprising a computer usable storage medium to store a computer readable program that, when executed on a computer, causes the computer to perform operations comprising:
execute a metaverse application, wherein the metaverse application enables an avatar of a first user to interact with avatars of other users within a metaverse virtual world;
convey a first representation of the avatar of the first user to a second user according to a default profile; and
simultaneously convey a second representation of the avatar of the first user to a third user according to an alternative profile.

2. The computer program product of claim 1, wherein the computer readable program, when executed on the computer, causes the computer to perform operations to allow the first user to configure profile characteristics of the default and the alternative profiles and to store the default and the alternative profiles in a memory storage device wherein each of the default and alternative profiles comprises at least one profile characteristic selected from the group consisting of hair color, hair style, clothing, age, gender, race, height, weight, body type, voice type, gestures, and allowed expressions.

3. The computer program product of claim 2, wherein the computer readable program, when executed on the computer, causes the computer to perform operations to allow the first user to configure a profile trigger and to store the profile trigger in a memory storage device, wherein the profile trigger comprises at least one trigger selected from the group consisting of an activation time, an activation location, and an activation contact, wherein the activation time comprises a time of day within the virtual world that indicates when the alternative profile is represented to another user, the activation location comprises a location within the virtual world that indicates where within the virtual world the alternative profile is represented to another user, and the activation contact comprises an identifier of another user's avatar that indicates to whom the alternative profile is represented.

4. The computer program product of claim 3, wherein the computer readable program, when executed on the computer, causes the computer to perform operations to dynamically recognize the profile trigger of the alternative profile and to dynamically implement the alternative profile in response to the profile trigger.

5. The computer program product of claim 3, wherein the computer readable program, when executed on the computer, causes the computer to perform operations to monitor at least one of a plurality of environmental cues of the metaverse virtual world, to compare at least one of the environmental cues to at least one of the profile triggers, and to implement the alternative profile in response to a match between at least one of the environmental cues and at least one of the profile triggers associated with the alternative profile, wherein the environmental cues comprise at least the time of day in the virtual world, the location of the avatar in the virtual world, and another avatar that is within a predetermined radius of the first user's avatar.

6. The computer program product of claim 3, wherein the computer readable program, when executed on the computer, causes the computer to perform operations to monitor profile characteristics of the third user's avatar and to send a monitor signal to the representation engine to instruct the representation engine to adapt at least one profile characteristic of the first user's avatar to match at least one of the profile characteristics of the third user's avatar, wherein the representation engine simultaneously represents at least one of the profile characteristics of the avatar of the first user to the third user according to the profile characteristics of the third user's avatar.

7. The computer program product of claim 3, wherein the computer readable program, when executed on the computer, causes the computer to perform operations to monitor a profile preference of the third user and to send a monitor signal to the representation engine to instruct the representation engine to adapt the appearance of the first user's avatar to match the profile preference, wherein the profile preference comprises at least one of the plurality of profile characteristics, and wherein at least one of the plurality of profile characteristics of the first user's profile that is represented to the third user as the first user's avatar is set equal to the at least one of the plurality of profile characteristics of the third user's profile preference.

8. The computer program product of claim 2, wherein the computer readable program, when executed on the computer, causes the computer to perform operations to receive an audio signal from an audio input device on a first client computer of the first user, to modify the audio signal according to the voice type associated with the alternative profile, and to output the modified audio signal to a second client computer of the second user.

9. The computer program product of claim 2, wherein the computer readable program, when executed on the computer, causes the computer to perform operations to receive a signal from a video input device on the first client computer of the first user, to analyze the signal, to generate the allowed expression associated with the alternative profile, and to output the generated expression to a second client computer of the second user.

10. A system comprising:
a metaverse server coupled to a network, the metaverse server to execute a metaverse application, wherein the metaverse application enables an avatar of a first user to interact with avatars of other users within a metaverse virtual world; and
a representation engine coupled to the metaverse server, the representation engine to convey a first representation of the avatar of the first user to a second user according to a default profile and to simultaneously convey a second representation of the avatar of the first user to a third user according to an alternative profile, wherein the alternative profile is different from the default profile.

11. The system of claim 10, wherein the representation engine comprises a profile configurator to allow the first user to configure profile characteristics of the default and the alternative profiles and to store the default and the alternative profiles in a memory storage device wherein each of the default and alternative profiles comprises at least one profile characteristic selected from the group consisting of hair color, hair style, clothing, age, gender, race, height, weight, body type, voice type, gestures, and allowed expressions.

12. The system of claim 11, wherein the profile configurator is further configured to allow the first user to configure a profile trigger and to store the profile trigger in a memory storage device, wherein the profile trigger comprises at least one trigger selected from the group consisting of an activation time, an activation location, and an activation contact, wherein the activation time comprises a time of day within the virtual world that indicates when the alternative profile is represented to another user, the activation location comprises a location within the virtual world that indicates where within the virtual world the alternative profile is represented to another user, and the activation contact comprises an identifier of another user's avatar that indicates to whom the alternative profile is represented.

13. The system of claim 12, wherein the representation engine is further configured to dynamically recognize a profile trigger of the alternative profile and to dynamically implement the alternative profile in response to the profile trigger.

14. The system of claim 12, the representation engine further comprising an environment monitor coupled to the profile configurator, the environment monitor to monitor at least one of a plurality of environmental cues of the metaverse virtual world, to compare at least one of the environmental cues to at least one of the profile triggers, and to implement the alternative profile in response to a match between at least one of the environmental cues and at least one of the profile triggers associated with the alternative profile, wherein the environmental cues comprise at least the time of day in the virtual world, the location of the avatar in the virtual world, and another avatar that is within a predetermined radius of the first user's avatar.

15. The system of claim 12, wherein the environment monitor is further configured to monitor profile characteristics of the third user's avatar and to send a monitor signal to the representation engine to instruct the representation engine to adapt at least one profile characteristic of the first user's avatar to match at least one of the profile characteristics of the third user's avatar, wherein the representation engine simultaneously represents the profile characteristics of the avatar of the first user to the third user according to the profile characteristics of the third user's avatar.

16. The system of claim 12, wherein the environment monitor is further configured to monitor a profile preference of the third user and to send a monitor signal to the representation engine to instruct the representation engine to adapt the appearance of the first user's avatar to match the profile preference of the third user, wherein the profile preference comprises at least one of the plurality of profile characteristics, and wherein at least one of the plurality of profile characteristics of the first user's profile that is represented to the third user as the first user's avatar is set equal to the at least one of the plurality of profile characteristics of the third user's profile preference.

17. The system of claim 11, further comprising a processor coupled to the representation engine, the processor to receive an audio signal from an audio input device on a first client computer of the first user, to modify the audio signal according to the voice type associated with the alternative profile, and to output the modified audio signal to a second client computer of the second user.

18. The system of claim 11, further comprising a processor coupled to the representation engine, the processor to receive a signal from a video input device on the first client computer of the first user, to analyze the signal, to generate the allowed expression associated with the alternative profile, and to output the generated expression to a second client computer of the second user.

19. A method comprising:
executing a metaverse application to enable an avatar of a first user to interact with avatars of other users within a metaverse virtual world;
conveying a first representation of the avatar of the first user to a second user according to a default profile;
recognizing a profile trigger associated with an alternative profile; and
dynamically conveying a second representation of the avatar of the first user to a third user according to the alternative profile while continuing to convey the first representation to the second user.

20. The method of claim 19, further comprising:
configuring profile characteristics of the default and alternative profiles, wherein each of the default and alternative profiles comprises at least one profile characteristic selected from the group consisting of hair color, hair style, clothing, age, gender, race, height, weight, body type, voice type, gestures, and allowed expressions;
configuring the profile trigger, wherein the profile trigger comprises at least one trigger selected from the group consisting of an activation time, an activation location, and an activation contact, wherein the activation time comprises a time of day within the virtual world that indicates when the alternative profile is represented to the third user, the activation location comprises a location within the virtual world that indicates where within the virtual world the alternative profile is represented to the third user, and the activation contact comprises an identifier of the third user's avatar that indicates to whom the alternative profile is represented;
storing the profiles and the profile trigger in a memory storage device;
monitoring at least one of a plurality of environmental cues of the metaverse virtual world, wherein the environmental cues comprise at least the time of day in the virtual world, the location of the first user's avatar in the virtual world, and another avatar that is within a predetermined radius of the first user's avatar;
comparing at least one of the environmental cues to at least one of the profile triggers; and
implementing the alternative profile in response to a match between at least one of the environmental cues and at least one of the profile triggers associated with the alternative profile.
